(19) United States
(12) Patent Application Publication
(10) Pub. No.: US 2019/0118124 A1
(43) Pub. Date: Apr. 25, 2019

(54) HYDROGEN WATER AND MAGNETIC WATER GENERATING WATER BOTTLE

(71) Applicant: Byung Wook JHEE, Seoul (KR)

(72) Inventor: Byung Wook JHEE, Seoul (KR)

(21) Appl. No.: 16/068,319

(22) PCT Filed: Feb. 23, 2017
(86) PCT No.: PCT/KR2017/002002

§ 371 Date: Jul. 5, 2018

(30) Foreign Application Priority Data
Feb. 24, 2016 (KR) 10-2016-0022167

(51) Int. Cl. B01D 35/06; C02F 1/48; C02F 1/50; C02F 1/68; C02F 1/72

(52) U.S. Cl. CPC B01D 35/06; C02F 1/48; C02F 1/50; B01D 2221/08; C02F 1/72; C02F 2307/02; C02F 1/68

(57) ABSTRACT

A hydrogen water and magnetic water generating water bottle simultaneously turns water filled into the water bottle into magnetic water and hydrogen water, enables both the top and bottom of the water bottle to be opened using top and bottom caps, enables the internal cleaning of the water bottle to be cleanly carried out, and enables the easy exchange of a magnetic water generating means and a hydrogen water generating means. The water bottle includes top and bottom opening parts. Magnetic water generating means is detachably provided to penetrate the top opening part, is disposed in the top of an inner part of the water bottle, and discharges upwardly the water filled into the water bottle. Hydrogen water generating means is detachably provided to penetrate the bottom opening part and is disposed in the bottom of the inner part.

### TECHNICAL FIELD

The present invention relates to a hydrogen water and magnetic water generating water bottle and more specifically, to a hydrogen water and magnetic water generating water bottle which can simultaneously turn water filling the water bottle into magnetic water and hydrogen water, enables both the top and bottom of the water bottle to be opened by means of top and bottom caps, enables the internal cleaning of the water bottle to be cleanly carried out, and enables the easy exchange of a magnetic water generating means and a hydrogen water generating means.

### RELATED ART

In general, the water quality of rivers, lakes, streams and the sea including groundwater has been polluted due to environmental pollution. Accordingly, the quality of drinking water has been deteriorated steadily. These days, most people use water purifiers which can purify water or purchase bottled water to drink clean and safe water.

However, no one can say for sure bottled water in the market is safe from bacteria or environmental pollution because people have witnessed a growing number of cases in which water drawn from spring water in the mountains and fields is contaminated with pathogenic bacteria or microorganisms due to various factors including environmental pollution, a mass kill of livestock, poultry, etc. and turns out to be unsafe for drinking.

For instance, although bottled water contains spring water that complies with standards for drinking-water quality, it is difficult to know how many bacteria remain in such spring water. Additionally, there is a problem with bottled water manufacturing processes. Further, according to a regulation, only underground water is appropriate for drinking. However, if underground water is contaminated with bacteria and is mixed with polluted water due to the pollution of underground water, consumers come to drink the contaminated underground water without knowing this.

In addition, although alkaline water has a PH greater than or equal to 7 and meets the standards for drinking-water quality, the water is also oxidized after the date of expiry, and due to the movements of water molecules which change a hundred million times per second.

Further, a water puffier has a structural problem. It removes even minerals good for the human health. Accordingly water purified by a water purifier is not that different from distilled water. Additionally, the water tank and tab of a water purifier can be a breeding ground for bacteria.

In addition, these days, people often purchase bottled water during outdoor activities such as exercising, climbing, etc. and in their daily lives or carry portable water bottles to contain clean drinking water in case they need water to drink.

Empty bottles can be used again to contain spring water in the mountains or to store water. In this case, water contained in the re-used bottle can be easily contaminated with bacteria and easily decayed. In particular, in summer, water in the re-used bottle is fast decayed because bacteria fast spread.

In general, people buy bottled water contained in a disposable plastic bottle and drink the water from the bottle by touching their mouth, carry the bottle to drink whenever they want to drink water and drink the bottled water again. In this case, people are vulnerable to germs that cause food poisoning or to food contaminated with bacteria.

Accordingly, there is a need to find out ways to prevent water contained in a disposable plastic bottle or portable water bottle etc. from decaying and make the water cleaner.

Korean Patent No. 1548469 titled “functional antibacterial water bottle” (hereinafter referred to as “conventional functional antibacterial water bottle”) that was filed by this applicant and registered is disclosed. The functional antibacterial water bottle is capable of preventing water in a portable water bottle etc. from decaying and capable of making the water cleaner.

The conventional functional antibacterial water bottle includes a water bottle for containing water and a cap; an inner cap installed at the inner side of the mouth of the water bottle and having a hole for pouring water; a tube perpendicularly disposed inside the water bottle, coupled to and supported by the inner cap through an upper end and having a functional member inside the tube; pure silver plates respectively installed at the upper and lower ends of the tube so as to sterilize bacteria in the air over the water and in the water by being exposed in the air and the water, wherein circular supporting bodies are respectively installed at the upper end or the lower end of the tube, are coupled to the bottom of the inner cap or are put at the inner bottom of the water bottle, and have holes through which a lid inserted into the tube and water pass.

Additionally, any one of a magnet, tourmaline, magnesium is solely used as functional materials inserted into the tube, or at least two of a magnet, tourmaline, magnesium are used together as functional materials inserted into the tube.

However, the conventional functional antibacterial water bottle with the above-described configuration may produce magnetic water through a magnet or generate hydrogen water by means of magnesium added but may not simultaneously produce magnetic water and hydrogen water.

Further, the conventional functional antibacterial water bottle has a cap only at the upper portion thereof. Accordingly, when cleaned, the inside of the water bottle may not be cleanly washed.

### DETAILED DESCRIPTION OF THE INVENTION

### Technical Problems

The present invention is devised to solve the above-described problems.

The purpose of the present invention is to provide a hydrogen water and magnetic water generating water bottle which can simultaneously turn water filling the water bottle into magnetic water and hydrogen water and enables both the top and bottom of the water bottle to be opened by means of top and bottom caps.

Another purpose of the present invention is to provide a hydrogen water and magnetic water generating water bottle which can prevent a magnet from contacting water by sealing and wrapping the magnet with an inner tube and a fixation seal tube.

Further, another purpose of the present invention is to provide a hydrogen water and magnetic water generating water bottle in which the inner tube constituting a magnetic water generating part further includes an advertising plate for advertisements formed at the outer side thereof.

Further, another purpose of the present invention is to provide a hydrogen water and magnetic water generating water bottle in which a silver plate is further provided at the top of a magnetic water generating means and sterilizes air filling a top opening part so as to prevent the air filling the top opening part from being polluted in advance.

Further, another purpose of the present invention is to provide a hydrogen water and magnetic water generating water bottle in which a silver plate is further provided at the bottom of the magnetic water generating means and sterilizes magnetized water so as to sterilize water filling the water bottle.

Further, another purpose of the present invention is to provide a hydrogen water and magnetic water generating water bottle in which the magnetic water generating means is prevented from completely being inserted into the water bottle in the process of inserting and installing the magnetic water generating means into the top opening part.

Further, another purpose of the present invention is to provide a hydrogen water and magnetic water generating water bottle in which a silver plate is further provided at the bottom of a hydrogen water generating part and sterilizes hydrogenated water.

Further, another purpose of the present invention is to provide a hydrogen water and magnetic water generating water bottle in which a perimeter packing is further provided around the bottom of a case constituting the hydrogen water generating means so as to improve the sealing power of a bottom cap.

Further, another purpose of the present invention is to provide a hydrogen water and magnetic water generating water bottle in which a silver plate is further provided at the top of the bottom plate of a bottom cap such that the water sunk at the bottom of the water bottle is sterilized.

### Technical Solutions

As a means to achieve the above-described purposes, a hydrogen water and magnetic water generating water bottle according to the present invention includes: a water bottle which includes a top opening part and a bottom opening part; a magnetic water generating means which is detachably provided so as to penetrate the top opening part, is disposed at the inner top of the water bottle, and discharges upwardly water filling the water bottle; a hydrogen water generating means which is detachably provided so as to penetrate the bottom opening part and is disposed at the inner bottom of the water bottle; a top cap which is detachably provided to the top opening part by means of a top detachable fixing means; and a bottom cap which is detachably provided to the bottom opening part by means of a bottom detachable fixing means.

Further, according to a hydrogen water and magnetic water generating water bottle of the present invention, the magnetic water generating means includes an insertion cap which is inserted into the top opening part, which has a plurality of water passing holes formed therearound and which has a fixing tube whose top and bottom are perpendicularly opened at the center of the insertion cap, and a magnetic water generating part whose top is inserted into and fixed to the fixing tube and which is disposed at the inner top of the water bottle so as to turn water filling the water bottle into magnetic water.

Further, according to a hydrogen water and magnetic water generating water bottle of the present invention, the magnetic water generating part includes a fixation seal tube whose top is inserted into and fixed to the fixing tube, whose inner top is opened and whose inner bottom is closed, a water magnetizing part which is inserted into the fixation seal tube, and a fixing tube sealing packing which is inserted into the inner top of the fixation seal tube.

Further, according to a hydrogen water and magnetic water generating water bottle of the present invention, the water magnetizing part includes an inner tube which is inserted into the fixation seal tube and whose inner top and bottom are closed by means of inner sealing packings, top and bottom magnets which are disposed apart from each other at the inner top and bottom of the inner tube by means of repulsive forces, and a functional ball which is incorporated between the top and bottom magnets.

Further, according to a hydrogen water and magnetic water generating water bottle of the present invention, the inner tube further includes an advertising plate for advertisements formed at the outer circumferential surface of the inner tube.

Further, according to a hydrogen water and magnetic water generating water bottle of the present invention, the fixing tube further includes a top plate with a plurality of air passing holes formed at the inner top of the fixing tube, and a silver plate is further provided between the bottom of the top plate and the top of the fixing tube sealing packing so as to sterilize air.

Further, according to a hydrogen water and magnetic water generating water bottle of the present invention, the fixation seal tube further includes a silver plate fixing cap which has a plurality of water passing holes formed at the bottom plate thereof and which is inserted into and fixed to the bottom of the fixation seal tube, a silver plate for sterilizing water is further provided between the bottom plate of the silver plate fixing cap and the bottom of the fixing tube, and a blocking plate is further provided between the bottom of the silver plate and the fixing tube sealing packing.

Further, according to a hydrogen water and magnetic water generating water bottle of the present invention, the top opening part is configured to be a perpendicular cylindrical tube, a perimeter lateral plate is further formed around the insertion cap, an insertion prevention protrusion protruding outwards is further formed at the top of the perimeter lateral plate, and a curb protrusion that protrudes inwards and curbs insertion of the insertion prevention protrusion is further formed at the bottom of the inner circumferential surface of the top opening part.

Further, according to a hydrogen water and magnetic water generating water bottle of the present invention, the hydrogen water generating means includes a case which is provided so as to penetrate the bottom opening part, which has an adherence perimeter plate formed at the bottom perimeter of the outer circumferential surface of the case and adhering to the lower end of the bottom opening part, whose inner top is closed and inner bottom is opened, and whose top and perimeter have a plurality of water passing holes; and a hydrogen water generating part which is incorporated into the case and turns water passing through the case into hydrogen water.

Further, according to a hydrogen water and magnetic water generating water bottle of the present invention, the hydrogen water generating part includes functional materials filling the inside of the case and a covering means for covering the inner bottom of the case.

Further, according to a hydrogen water and magnetic water generating water bottle of the present invention, the hydrogen water generating part includes an inner case which is inserted into the case, has a top lid, has a plurality of water passing holes around the inner case and at the top and bottom of the inner case and builds a plurality of functional materials therein, and a covering means for covering the inner bottom of the case.

Further, according to a hydrogen water and magnetic water generating water bottle of the present invention, the covering means includes filter members 351 inserted into the inner bottom of the case so as to allow water to pass and having vertical holes whose top and bottom are opened and which are formed at the center of the filter members, top and bottom mesh plates inserted into and fixed to the top and bottom of the vertical holes so as to allow water to pass, and a silver plate S incorporated between the top and bottom mesh plates to sterilize water.

Further, according to a hydrogen water and magnetic water generating water bottle of the present invention, the bottom opening part is configured to be a perpendicular cylindrical tube, a perimeter protruding plate is further formed at the bottom of the inner circumferential surface of the bottom opening part, and a perimeter packing is further provided around the adherence perimeter plate such that the perimeter packing wraps the end and the top and bottom of the perimeter of the adherence perimeter plate and that top and bottom of the perimeter packing adhere to the bottom of the perimeter protruding plate and the top of the bottom plate of the bottom cap.

Further, according to a hydrogen water and magnetic water generating water bottle of the present invention, a silver plate is further attached to the top of the bottom plate of the bottom cap.

### Advantageous Effects

The present invention with the above-described configuration has the advantage of simultaneously turning water filling a water bottle into magnetic water and hydrogen water. Further, the present invention enables both the top and bottom of the water bottle to be opened by means of top and bottom caps such that the internal cleaning of the water bottle is cleanly carried out and of enabling the easy exchange of a magnetic water generating means and a hydrogen water generating means.

Further, the present invention wraps and seals magnets twice by means of an inner tube and a fixation seal tube such that the magnets are completely prevented from contacting water. Accordingly, the present invention provides a water bottle in which water can be prevented in advance from pollution caused by direct contact with the magnets, thereby improving safety.

Further, the present invention further includes an advertising plate formed at the outer side of the inner tube constituting a magnetic water generating part for advertisements.

Further, the present invention further includes a silver plate which is provided at the top of the magnetic water generating means and sterilizes air filling the top opening part so as to prevent the air filling the top opening part from being polluted, thereby capable of preventing water pollution caused by pollution of air filling the top opening part.

Further, the present invention further includes a silver plate which is provided at the bottom of the magnetic water generating means and sterilizes magnetized water such that the water filling the water bottle is sterilized.

Further, the present invention prevents the magnetic water generating means from completely being inserted into the water bottle in the process of inserting and installing the magnetic water generating means into the top opening part thereby improving convenience at the time of the insertion and installation of the magnetic water generating means.

Further, the present invention further includes a silver plate which is provided at the bottom of a hydrogen water generating part and sterilizes hydrogenated water so as to sterilize hydrogenated water.

Further, the present invention further includes a perimeter packing around the bottom of a case constituting a hydrogen water generating means so as to improve the sealing power of a bottom cap such that the water in the water bottle is prevented from leaking out of the bottom of the water bottle while the water bottle is being used.

Further, the present invention further includes a silver plate provided at the top of the bottom plate of the bottom cap such that the water sunk at the bottom of the water bottle is sterilized.

### BRIEF DESCRIPTION OF THE DRAWINGS

FIG. 1 is a view illustrating a water bottle according to the present invention.

FIG. 1A is a perspective view of a water bottle according to the present invention.

FIG. 1B is an exploded perspective view of a water bottle according to the present invention.

FIG. 1C is a sectional view illustrating a section cut along the line A-A in FIG. 1A.

FIG. 2 is a view of a magnetic water generating means constituting the present invention.

FIG. 2A is a perspective view of a magnetic water generating means constituting the present invention.

FIG. 2B is an exploded perspective view of a magnetic water generating means constituting the present invention.

FIG. 3C is a sectional view illustrating a section cut along the line B-B in FIG. 2A.

FIG. 3 is an enlarged view of portion C in FIG. 1C.

FIG. 4 is a sectional view illustrating another embodiment of a covering means constituting the present invention.

FIG. 5 is a sectional view illustrating another embodiment of a hydrogen water generating means constituting the present invention.

### MODE FOR CARRYING OUT THE INVENTION

Below, the present invention will be described in detail with reference to the attached drawings illustrating preferred embodiments of the present invention. However, the present invention may be embodied in various different forms. Accordingly, it should be understood that the present invention is construed as being limited to the embodiments set forth herein.

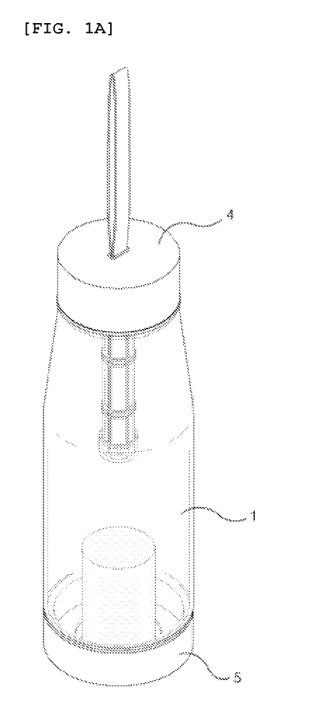

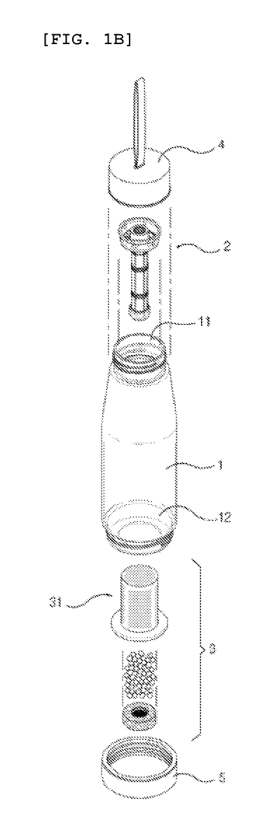

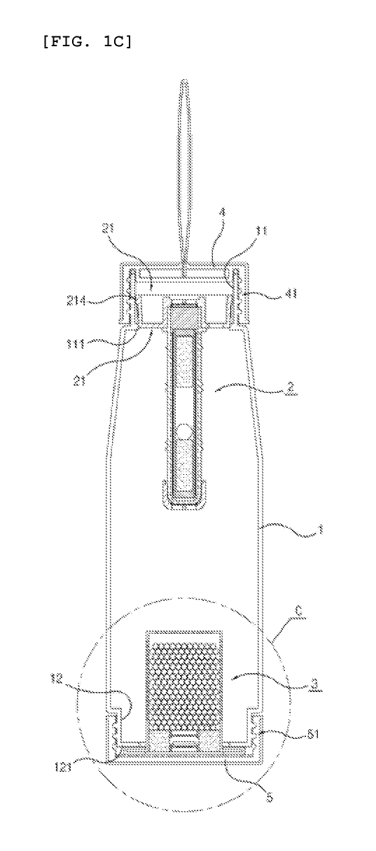

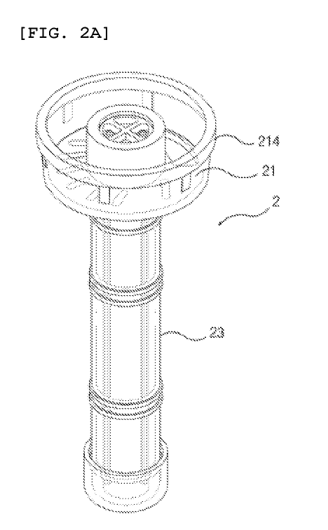

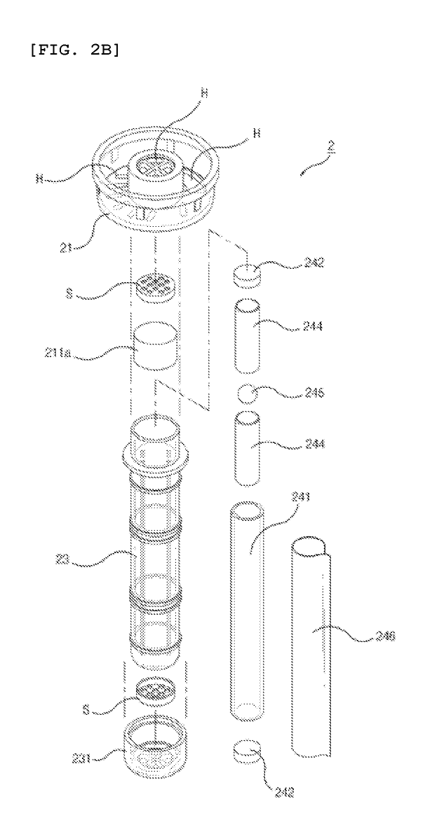

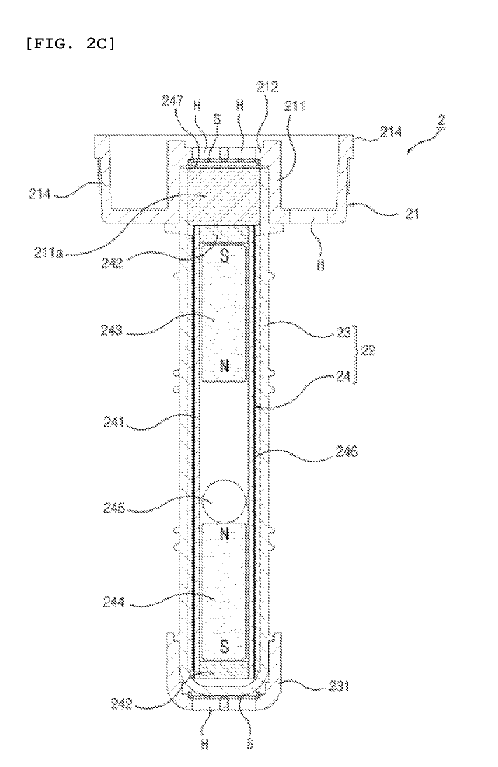

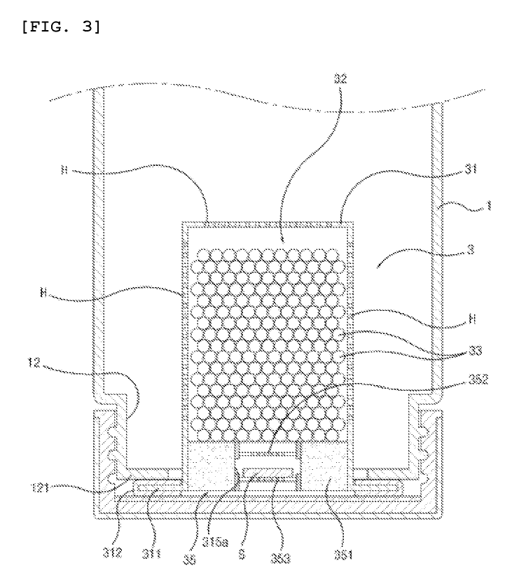

FIG. 1 is a view illustrating a water bottle according to the present invention, FIG. 1A is a perspective view of a water bottle according to the present invention, FIG. 1B is an exploded perspective view of a water bottle according to the present invention, and FIG. 1C is a sectional view illustrating a section cut along the line A-A in FIG. 1A. Additionally, FIG. 2 is a view of a magnetic water generating means constituting the present invention, FIG. 2A is a perspective view of a magnetic water generating means constituting the present invention, FIG. 2B is an exploded perspective view of a magnetic water generating means constituting the present invention, and FIG. 3C is a sectional view illustrating a section cut along the line B-B in FIG. 2A. Further, FIG. 3 is an enlarged view of portion C in FIG. 1C.

As illustrated in the drawings, a water bottle 1 according to the present invention includes a water bottle 1 provided with a top opening part 11 and a bottom opening part 12, a magnetic water generating means 2 detachably provided to penetrate the top opening part 11, a hydrogen water generating means 3 detachably provided to penetrate the bottom opening part 12, a top cap 4 detachably provided to the top opening part 11, and a bottom cap 5 detachably provided to the bottom opening part 12.

The water bottle 1 preferably consists of transparent materials or translucent materials such that the inside of the water bottle is seen from the outside. Further, the water bottle 1 may consist of synthetic resins or glass.

Additionally, the top and bottom opening parts 11, 12 formed at the top and bottom of the water bottle 1 are preferably configured to be a perpendicular cylindrical tube such that the top cap 4 and bottom cap 5 are detachably installed.

Further, the magnetic water generating means 2 constituting the present invention, as illustrated in FIGS. 1 and 2, is detachably provided to penetrate the top opening part 11 and disposed at the top of the inside of the water bottle so as to turn water filling the water bottle 1 into magnetic water.

Preferably, the magnetic water generating means 2 playing the above-described role includes an insertion cap 21 which is inserted into the top opening part 11, which has a plurality of water passing holes H formed therearound so as to discharge water filling the water bottle 1 upwards and which has a fixing tube 211 whose top and bottom are perpendicularly opened at the center of the insertion cap, and a magnetic water generating part 22 whose top is inserted into and fixed to the fixing tube 211 and which is disposed at the inner top of the water bottle 1 so as to turn water filling the water bottle 1 into magnetic water.

Preferably, the magnetic water generating part 22 includes a fixation seal tube 23 whose top is inserted into and fixed to the fixing tube 211, whose inner top is opened and whose inner bottom is closed, a water magnetizing part 24 which is inserted into the fixation seal tube 23, and a fixing tube sealing packing 211A which is inserted into the inner top of the fixation seal tube 23 so as to prevent water from infiltrating inwards. Additionally, the fixing tube sealing packing 211A preferably consists of synthetic resins or silicone that causes no harm to the human body.

The water magnetizing part 24 preferably includes an inner tube 241 which is inserted into the fixation seal tube 23 and whose inner top and bottom are closed by means of inner sealing packings 242, and top and bottom magnets 243, 244 which are disposed apart from each other at the inner top and bottom of the inner tube 241 by means of repulsive forces, and a functional ball 245 which is incorporated between the top and bottom magnets 243, 244 such that the water magnetizing part 24 magnetizes water while the water magnetizing part 24 does not contact the water. According to the present invention, the top and bottom magnets 243, 244 are wrapped and sealed twice by the inner tube 241 and the fixation seal tube 23 such that the magnets are completely prevented from contacting water. Accordingly, the present invention provides a water bottle in which water can be prevented from being polluted by contacting the magnets, thereby improving safety.

The functional ball 245 preferably consists of any one of a magnesium ball, an alkali ball, a calcium ball, a bio-ceramic ball, a barley stone ball, a magnetite ball and a tourmaline ball. Accordingly, the present invention is further provided with the functional ball 245 between the top and bottom magnets 243, 244 constituting the magnetic water generating part such that functional ingredients are infiltrated into the magnetized water at the time of magnetizing water.

Preferably, the inner tube 241 further includes an advertising plate 246 for advertisements formed at the outer circumferential surface of the inner tube 241.

Meanwhile, a top plate 212 with a plurality of air passing holes A may be further formed at the inner top of the fixing tube 211, and a silver plate S may be further formed between the bottom of the top plate 212 and the top of the fixing tube sealing packing 211A so as to sterilize air. The present invention further includes the silver plate S which is provided at the top of the magnetic water generating means 2 and sterilizes air filling the top opening part 11 so as to prevent the air filling the top opening part 11 from being polluted, thereby capable of preventing water pollution that might be caused by pollution of water filling the top opening part 11.

Additionally, a blocking plate 247 is preferably provided between the bottom of the silver plate S and the fixing tube sealing packing 211A so as to prevent water from contacting the fixing tube sealing packing 211 A, and the blocking plate 247 preferably consists of metals such as stainless steel etc. that causes no harm to the human body.

Further, a silver plate fixing cap 231 that has a plurality of water passing holes H formed at the bottom plate thereof may be further inserted into and fixed to the bottom of the fixation seal tube 23, and a silver plate S for sterilizing water may be further provided between the bottom plate of the silver plate fixing cap 231 and the bottom of the fixing tube 211. Accordingly, the present invention further includes the silver plate S for sterilizing magnetized water which is provided at the bottom of the magnetic water generating means 2 such that the water filling the water bottle 1 is sterilized.

Further, the top opening part 11, as described above, is configured to be a perpendicular cylindrical tube, a perimeter lateral plate 213 is further formed around the insertion cap 21, an insertion prevention protrusion 214 protruding outwards is further formed at the top of the perimeter lateral plate 213, and a curb protrusion 111 that protrudes inwards and curbs insertion of the insertion prevention protrusion 214 may be further formed at the bottom of the inner circumferential surface of the top opening part 11. Accordingly, the insertion prevention protrusion 214 formed at the insertion cap 21 stumbles over the insertion prevention protrusion 214 formed at the top opening part 11 in the process of inserting and installing the magnetic water generating means 2 into the top opening part 11 so as to prevent the magnetic water generating means 2 from completely being inserted into the water bottle 1 thereby improving convenience at the time of the insertion and installation of the magnetic water generating means 2 according to the present invention.

Further, the hydrogen water generating means 3 constituting the present invention, as illustrated in FIGS. 1 to 3, is detachably provided so as to penetrate the bottom opening part 12 and is disposed at the inner bottom of the water bottle 1 so as to turn the water filling the water bottle 1 into hydrogen water.

Most preferably, the hydrogen water generating means 3 playing the above-described role consists of a case 31 which is provided so as to penetrate the bottom opening part 12, which has an adherence perimeter plate 311 formed at the bottom perimeter of the outer circumferential surface of the case and adhering to the lower end of the bottom opening part 12, whose inner top is closed and inner bottom is opened, and whose top and perimeter have a plurality of water passing holes H, and a hydrogen water generating part 32 which is incorporated into the case and turns water passing through the case 31 into hydrogen water.

The hydrogen water generating part 32 preferably consists of functional materials 33 filling the inside of the case 31 and a covering means 35 for covering the inner bottom of the case 31 such that the hydrogen water generating part 32 contacts water to generate hydrogen water.

Preferably, any one of a magnesium ball, an alkali ball, a calcium ball, a bio-ceramic ball, a barley stone ball, a magnetite ball and a tourmaline ball is solely used as functional materials 33, or at least two of a magnesium ball, an alkali ball, a calcium ball, a bio-ceramic ball, a barley stone ball, a magnetite ball and a tourmaline ball are used together as functional materials 33.

The covering means 35 preferably consists of filter members 351 inserted into the inner bottom of the case 31 so as to allow water to pass and having vertical holes 351A whose top and bottom are opened and which are formed at the center of the filter members 351, top and bottom mesh plates 352, 353 inserted into and fixed to the top and bottom of the vertical holes 351A so as to allow water to pass, and a silver plate S incorporated between the top and bottom mesh plates 352, 353 and sterilizing water such that water is sterilized while passing. Accordingly, the present invention further includes the silver plate S which is provided at the bottom of the hydrogen water generating part 32 and sterilizes hydrogenated water.

Meanwhile, the bottom opening part 12, as illustrated above, is configured to be a perpendicular cylindrical tube and may further have a perimeter protruding plate 121 formed at the bottom of the inner circumferential surface of the bottom opening part 12. Additionally, a perimeter packing 312 may be further provided around the adherence perimeter plate 311 such that the perimeter packing 312 wraps the end and the top and bottom of the perimeter of the adherence perimeter plate 311 and that top and bottom surfaces of the perimeter packing 312 adhere to the bottom of the perimeter protruding plate 121 and the top of the bottom plate of the bottom cap 5. Accordingly, the present invention further includes the perimeter packing 312 around the bottom of the case 31 constituting the hydrogen water generating means 3 so as to improve the sealing power of the bottom cap 5 thereby preventing the water in the water bottle 1 from leaking out of the bottom of the water bottle 1 in advance while the water bottle is being used.

Additionally, a silver plate is preferably attached to the top of the bottom plate of the bottom cap 5 such that the water sunk at the bottom of the water bottle 1 is sterilized.

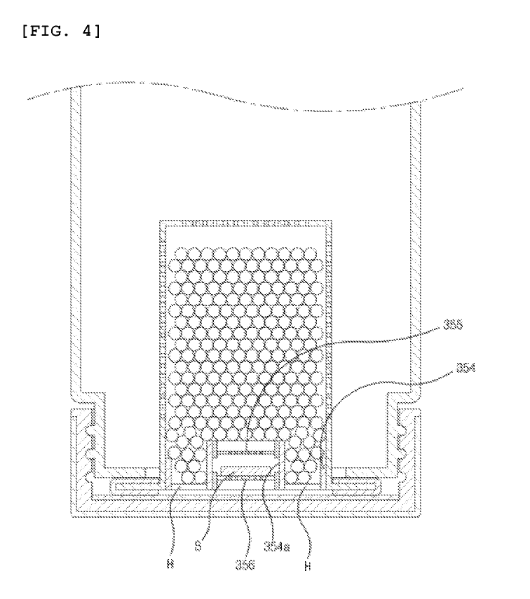

Further, the covering means 35, as illustrated in FIG. 4, may consist of bottom covering plates 354 inserted into the inner bottom of the case 31, having a plurality of water passing holes H around the bottom covering plates and having vertical tubes whose top and bottom are opened and which are formed at the center of the bottom covering plates, top and bottom mesh plates 355, 356 inserted into and fixed to the top and bottom of the vertical tubes so as to allow water to pass, and a silver plate S incorporated between the top and bottom mesh plates 355, 356 and sterilizing water such that water is sterilized while passing.

Further, the top cap 4 constituting the present invention, as illustrated in FIGS. 1 and 3, is detachably provided at the top opening part 11 by means of top detachable fixing means 41. Additionally, the top detachable fixing means 41 are preferably configured to be screw coupling parts formed at the outer circumferential surface of the top opening part 11 and the inner circumferential surface of the top cap 4 so as to readily open the top cap 4.

Meanwhile, the bottom cap 5 is detachably provided at the bottom opening part 12 by means of bottom detachable fixing means 51. Additionally, the top and bottom opening parts 12 are preferably configured to be screw coupling parts formed at the outer circumferential surface of the bottom opening part 12 and the inner circumferential surface of the bottom cap 5 so as to readily open the bottom cap 5.

Below, the operation of a water bottle 1 according to the present invention with the above-described configuration will be described.

As illustrated in FIGS. 1 to 3, a water bottle 1 according to the present invention is filled with water, and afterwards, water is magnetized by means of the magnetic force of top magnets, which released out of a magnetic water generating means 2 provided at the inner top of the water bottle 1. Additionally, magnetic water generated in this way may refine water molecules, control bacteria and remove scales. Further, the water may facilitate the growth of plant and animals and may have a strong cleaning ability. For instance, magnetic water has a different molecular structure from usual water because the molecular structure of usual water is changed by means of magnetic force. Accordingly, magnetic water denotes water having an unusual molecular structure. That is, when water passes through magnetic force of a permanent magnet, the molecular structure of water is ion-activated, and afterwards, magnetic water which is abundant with minerals, becomes weak alkaline water and has a hexagonal shape is generated.

Further, the present invention, as described above, generates magnetic water and at the same time, water contacts functional materials 33 of the hydrogen water generating means 3 provided at the inner bottom of the water bottle 1 such that the water contacting the functional materials 33 is turned into hydrogen water and functional water. Additionally, hydrogen water generated in this way functions as water that is good for health thanks to the functional materials 33. Hydrogen water will not be described in detail because it is already widely known.

As a result, water in the water bottle 1 may be simultaneously turned into magnetic water and hydrogen water according to the present invention.

Further, the top and bottom of the water bottle 1 may be opened by means of the top and bottom caps 4, 5 according to the present invention. Accordingly, the inside of the water bottle may be cleanly washed, and the magnetic water generating means 2 and hydrogen water generating means 3 may be readily exchangeable.

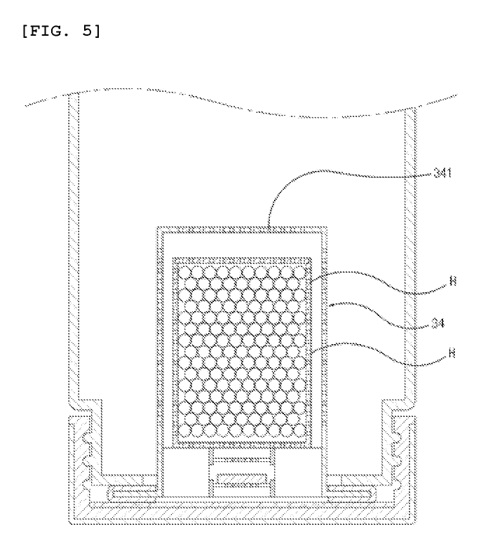

FIG. 5 is a sectional view illustrating another embodiment of a hydrogen water generating means 3 constituting the present invention.

Another embodiment of a hydrogen water generating means 3 constituting the present invention, as illustrated in FIG. 5, includes the elements of an embodiment of the hydrogen water generating means 3 which has be described above, except for the hydrogen water generating part 32 constituting an embodiment of the hydrogen water generating means 3 which has be described above.

Accordingly, the hydrogen water generating part 32 constituting another embodiment of a hydrogen water generating means 3 of the present invention includes an inner case 34 which is inserted into the case 31, has a top lid 341, has a plurality of water passing holes H around the inner case and at the top and bottom of the inner case and builds a plurality of functional materials 33 therein, and a covering means 35 for covering the inner bottom of the case 31.

Additionally, any one of a magnesium ball, an alkali ball, a calcium ball, a bio-ceramic ball, a barley stone ball, a magnetite ball and a tourmaline ball is solely used as functional materials 33, or at least two of a magnesium ball, an alkali ball, a calcium ball, a bio-ceramic ball, a barley stone ball, a magnetite ball and a tourmaline ball are used together as functional materials 33 so as to turn contacted water in the water bottle into hydrogen water or functional water.

As a result, according to another embodiment of a hydrogen water generating means 3 of the present invention, the balls that are functional materials 33 are readily replaced when the inner case 34 is replaced because a plurality of balls constituting functional materials fill the inner case 34.

The preferred embodiments of the present invention have been described. However, the present invention may use various modifications, changes and equivalents. It is apparent that the above-described embodiments of the present invention may be properly modified and applied. Accordingly, the scope of the right to the present invention, which is defined by the appended claims, should not be construed as being limited to the above-described embodiments.

Meanwhile, the detailed embodiments of the present invention have been described in the section of the detailed description of the invention. However, it will apparent to those having ordinary skill in the art to which the present invention pertains that the present invention may be modified in different forms within the scope of the present invention.

### DESCRIPTION OF THE SYMBOLS

1: Water bottle
11: Top opening part
111: Curb protrusion
12: Bottom opening part
121: Perimeter protruding plate
2: Magnetic water generating means
21: Insertion cap
211: Fixing tube, 212: Top plate 213: Perimeter lateral plate
214: Insertion prevention protrusion
22: Magnetic water generating part
23: Fixation seal tube
231: Silver plate fixing cap
24: Water magnetizing part
241: Inner tube, 242: Inner sealing packing, 243: Top magnet
244: Bottom magnet, 245: Functional ball, 246: Advertising plate
247: Blocking plate
3: Hydrogen water generating means
31: Case
311: Adherence perimeter plate 312: Perimeter packing
32: Hydrogen water generating part
33: Functional material
34: Inner case
341: Top lid
35: Covering means
351: Filter member, 352: Top mesh plate, 353: Bottom mesh plate
354: Bottom cover plate, 355: Top mesh plate, 356: Bottom mesh plate
4: Top cap
41: Top detachable fixing means
5: Bottom cap
51: Bottom detachable fixing means
H: Water passing hole
A: Air passing hole
S: Silver plate

1. A hydrogen water and magnetic water generating water bottle comprising:
a water bottle which comprises a top opening part and a bottom opening part;
a magnetic water generating means which is detachably provided so as to penetrate the top opening part, is disposed at the inner top of the water bottle, and discharges upwards water filling the water bottle;
a hydrogen water generating means which is detachably provided so as to penetrate the bottom opening part and is disposed at the inner bottom of the water bottle;
a top cap which is detachably provided to the top opening part by means of a top detachable fixing means; and
a bottom cap which is detachably provided to the bottom opening part by means of a bottom detachable fixing means,
wherein:
the magnetic water generating means comprises an insertion cap which is inserted into the top opening part, which has a plurality of water passing holes formed therearound and which has a fixing tube whose top and bottom are perpendicularly opened at the center of the insertion cap, and a magnetic water generating part whose top is inserted into and fixed to the fixing tube and which is disposed at the inner top of the water bottle so as to turn water filling the water bottle into magnetic water,
the magnetic water generating part comprises a fixation seal tube whose top is inserted into and fixed to the fixing tube, whose inner top is opened and whose inner bottom is closed, a water magnetizing part which is inserted into the fixation seal tube, and a fixing tube sealing packing which is inserted into the inner top of the fixation seal tube,
the water magnetizing part comprises an inner tube which is inserted into the fixation seal tube and whose inner top and bottom are closed by means of inner sealing packings, top and bottom magnets which are disposed apart from each other at the inner top and bottom of the inner tube by means of repulsive forces, and a functional ball which is incorporated between the top and bottom magnets,
the fixation seal tube is comprised of transparent or translucent materials,
the inner tube further comprises an advertising plate formed at the outer circumferential surface thereof,
the fixing tube further comprises a top plate that has a plurality of air passing holes at the inner top of the fixing tube,
a silver plate is further provided between the bottom of the top plate and the top of the fixing tube sealing packing so as to sterilize air, and
a blocking plate is further provided between the bottom of the silver plate and the fixing tube sealing packing.

2. The hydrogen water and magnetic water generating water bottle according to claim 1, wherein the functional ball is comprised of any one of a magnesium ball, an alkali ball, a calcium ball, a bio-ceramic ball, a barley stone ball, a magnetite ball and a tourmaline ball.

3. The hydrogen water and magnetic water generating water bottle according to claim 1, wherein:
the fixation seal tube further comprises a silver plate fixing cap which has a plurality of water passing holes formed at the bottom plate thereof and which is inserted into and fixed to the bottom of the fixation seal tube, and
a silver plate for sterilizing water is further provided between the bottom plate of the silver plate fixing cap and the bottom of the fixing tube.

4. The hydrogen water and magnetic water generating water bottle according to claim 1, wherein:
the top opening part is configured to be a perpendicular cylindrical tube,
a perimeter lateral plate is further formed around the insertion cap,
an insertion prevention protrusion protruding outwards is further formed at the top of the perimeter lateral plate, and
a curb protrusion that protrudes inwards and curbs insertion of the insertion prevention protrusion is further formed at the bottom of the inner circumferential surface of the top opening part.

5. The hydrogen water and magnetic water generating water bottle according to claim 1, wherein the hydrogen water generating means comprises:
a case which is provided so as to penetrate the bottom opening part, which has an adherence perimeter plate formed at the bottom perimeter of the outer circumferential surface of the case and adhering to the lower end of the bottom opening part, whose inner top is closed and inner bottom is opened, and whose top and perimeter have a plurality of water passing holes; and
a hydrogen water generating part which is incorporated into the case and turns water passing through the case into hydrogen water.

6. The hydrogen water and magnetic water generating water bottle according to claim 5, wherein the hydrogen water generating part comprises:
functional materials filling the inside of the case; and
a covering means covering the inner bottom of the case.

7. The hydrogen water and magnetic water generating water bottle according to claim 5, wherein the hydrogen water generating part comprises:
an inner case which is inserted into the case, has a top lid, has a plurality of water passing holes around the inner case and at the top and bottom of the inner case and builds a plurality of functional materials therein; and
a covering means for covering the inner bottom of the case.

8. The hydrogen water and magnetic water generating water bottle according to claim 6, wherein any one of a magnesium ball, an alkali ball, a calcium ball, a bio-ceramic ball, a barley stone ball, a magnetite ball and a tourmaline ball is solely used as functional materials, or at least two of a magnesium ball, an alkali ball, a calcium ball, a bio-ceramic ball, a barley stone ball, a magnetite ball and a tourmaline ball are used together as functional materials.

9. The hydrogen water and magnetic water generating water bottle according to claim 6, wherein the covering means comprises:
filter members inserted into the inner bottom of the case so as to allow water to pass and having vertical holes whose top and bottom are opened and which are formed at the center of the filter members;
top and bottom mesh plates inserted into and fixed to the top and bottom of the vertical holes so as to allow water to pass; and
a silver plate incorporated between the top and bottom mesh plates to sterilize water.

10. The hydrogen water and magnetic water generating water bottle according to claim 6, wherein the covering means comprises:
bottom covering plates inserted into the inner bottom of the case, having a plurality of water passing holes therearound and having vertical tubes whose top and bottom are opened and which are formed at the center of the bottom covering plates;
top and bottom mesh plates inserted into and fixed to the top and bottom of the vertical tubes so as to allow water to pass; and
a silver plate incorporated between the top and bottom mesh plates so as to sterilize water.

11. The hydrogen water and magnetic water generating water bottle according to claim 5, wherein:
the bottom opening part is configured to be a perpendicular cylindrical tube,
a perimeter protruding plate is further formed at the bottom of the inner circumferential surface of the bottom opening part, and
a perimeter packing is further provided around the adherence perimeter plate such that the perimeter packing wraps the end and the top and bottom of the perimeter of the adherence perimeter plate and that top and bottom of the perimeter packing adhere to the bottom of the perimeter protruding plate and the top of the bottom plate of the bottom cap.

12. The hydrogen water and magnetic water generating water bottle according to claim 1, wherein a silver plate is further attached to the top of the bottom plate of the bottom cap.

13. The hydrogen water and magnetic water generating water bottle according to claim 1, wherein:
the top and bottom opening parts are configured to be a perpendicular cylindrical tube,
the top detachable fixing means is comprised of screw coupling parts formed at the outer circumferential surface of the top opening part and at the inner circumferential surface of the top cap, and
the bottom detachable fixing means is comprised of screw coupling parts formed at the outer circumferential surface of the bottom opening part and at the inner circumferential surface of the bottom cap.

14. The hydrogen water and magnetic water generating water bottle according to claim 7, wherein any one of a magnesium ball, an alkali ball, a calcium ball, a bio-ceramic ball, a barley stone ball, a magnetite ball and a tourmaline ball is solely used as functional materials, or at least two of a magnesium ball, an alkali ball, a calcium ball, a bio-ceramic ball, a barley stone ball, a magnetite ball and a tourmaline ball are used together as functional materials.

15. The hydrogen water and magnetic water generating water bottle according to claim 7, wherein the covering means comprises:
filter members inserted into the inner bottom of the case so as to allow water to pass and having vertical holes whose top and bottom are opened and which are formed at the center of the filter members;
top and bottom mesh plates inserted into and fixed to the top and bottom of the vertical holes so as to allow water to pass; and
a silver plate incorporated between the top and bottom mesh plates to sterilize water.

16. The hydrogen water and magnetic water generating water bottle according to claim 7, wherein the covering means comprises:
bottom covering plates inserted into the inner bottom of the case, having a plurality of water passing holes therearound and having vertical tubes whose top and bottom are opened and which are formed at the center of the bottom covering plates;
top and bottom mesh plates inserted into and fixed to the top and bottom of the vertical tubes so as to allow water to pass; and
a silver plate incorporated between the top and bottom mesh plates so as to sterilize water.

17. The hydrogen water and magnetic water generating water bottle according to claim 5, wherein a silver plate is further attached to the top of the bottom plate of the bottom cap.
